(19) United States
(12) Patent Application Publication
(10) Pub. No.: US 2013/0192175 A1
(43) Pub. Date: Aug. 1, 2013

(54) Method and Apparatus for Preparing Portions

(71) Applicants: Gregor Matysiak, Breidenbach (DE); Christoph Eckhardt, Breidenbach (DE); Alexander Burk, Breidenbach (DE); Andreas Harder, Breidenbach (DE); Thomas Nispel, Breidenbach (DE); Sven Schuster, Breidenbach (DE); Andreas Kretzer, Breidenbach (DE)

(72) Inventors: Gregor Matysiak, Breidenbach (DE); Christoph Eckhardt, Breidenbach (DE); Alexander Burk, Breidenbach (DE); Andreas Harder, Breidenbach (DE); Thomas Nispel, Breidenbach (DE); Sven Schuster, Breidenbach (DE); Andreas Kretzer, Breidenbach (DE)

(73) Assignee: Weber Maschinenbau GmbH Breidenbach, Breidenbach (DE)

(21) Appl. No.: 13/739,651

(22) Filed: Jan. 11, 2013

(30) Foreign Application Priority Data
Jan. 13, 2012 (DE) 102012000545.8

(51) Int. Cl. B65B 35/52; B26D 7/32

(52) U.S. Cl. CPC B65B 35/52; B26D 7/32
USPC 53/514; 83/23; 83/91

(57) ABSTRACT

An apparatus for the automatic preparation of portions of a plurality of food products of different types comprises a conveying device which is configured to convey at least one product carrier from a product slice placement zone of a first cutting apparatus in which a part portion of at least one product slice of a first type is formed on the product carrier to a product slice placement zone of a second cutting apparatus in which a part portion of at least one product slice of a second type is formed on the product carrier which, together with the first portion, forms a desired total portion no longer to be complemented or a part portion still to be complemented by means of a further cutting apparatus.

### CROSS REFERENCE TO RELATED APPLICATIONS

This patent application claims the benefit of priority to German Patent Application Serial No. 102012000545.8, filed Jan. 13, 2012, which is incorporated herein by reference in its entirety.

### FIELD OF THE INVENTION

The present invention relates to a method for the automatic preparation of portions of a plurality of food products of different types by means of at least two cutting apparatus, in particular high-performance slicers.

### BACKGROUND

Buyers of packed food slices increasingly desire so-called multitype packs or mixed packs, i.e. slices of different product types packed together. It is, for example, desired that different types of sausage, different types of cheese or both slices of sausage and slices of cheese are contained in a single pack.

It is possible with modern high-performance slicers to cut off individual product slices from a product bar or a product loaf at a high cutting speed. Cut-off product slices and product portions of a specific product type comprising a plurality of product slices can equally be transported away from a slicer relatively fast by means of conveying devices such as belt conveyors or band conveyors and can, for example, be supplied to a packaging machine. Mixed portions of a plurality of products of different types, however, have to be assembled by hand. This manual work required to produce the above-mentioned multitype packs is not only tiresome, but also time-consuming and cost-intensive.

There is therefore the need to automate the preparation of portions of a plurality of food products of different types.

### SUMMARY

In accordance with the invention, at least one product slice is cut off from a product of a first type by means of a first cutting apparatus, with the cut-off product slice of the first type falling onto a product carrier and forming a first part portion. The product carrier having the first part portion is conveyed to a second cutting apparatus by means of a conveying device. At least one product slice of a second type is cut off by means of the second cutting apparatus, with the cut-off product slice of the second type falling onto the product carrier and forming a second part portion which complements the first part portion to form a desired total portion no longer to be complemented or to form a part portion still be complemented by means of at least one further cutting apparatus.

In accordance with the invention, two separate cutting apparatus are therefore utilized to slice products of different types. The mixed portion of the products of different types is then assembled on the product carrier which is movable by means of the conveying device from one of the cutting apparatus to the other cutting apparatus. The preparation of mixed portions can take place fully automatically due to the transfer of the product carrier between the cutting apparatus without an operator having to join the individual part portions of one product type to the mixed portion. A significant efficiency increase thus results overall in the manufacture of packed food portions.

It must generally be pointed out that not only different kinds of meat, sausage or cheese of different product types can be formed in the sense of the present invention, but also products of the same kind which differ from one another with respect to a relevant parameter from the viewpoint of the consumer. For example, salami slices with a large diameter and salami slices with a small diameter are to count as different product types in the sense of the invention. Differences which cannot be perceived by or are completely irrelevant for the consumer such as naturally occur in all food products should, however, not be covered by the expression “different type”, with this, however, nevertheless being possible in accordance with the invention.

The product carrier is moved by means of an adjustment device after the reception of the first part portion and before the reception of the second part portion such that the position of the second part portion on the product carrier relative to the position of the first part portion on the product carrier satisfies a predefined condition. It can be prevented by such a movement of the product carrier that all the product slices come to lie over one another and the lower product slices are thus not visible for a consumer. Instead, the individual part portions can be placed on the product carrier offset from one another, for example overlapping or in round placement, by the movement of the product carrier. An appealing appearance of the prepared total portion can therefore be achieved.

In accordance with an embodiment of the invention, the product carrier is displaced relative to a support surface of the conveying device, in particular in or against the conveying direction or transversely to the conveying direction. The process of displacing can take place before, after or during the actual conveying. The product carrier can specifically be moved continuously in the conveying direction and can simultaneously be displaced on the support surface.

In accordance with a further embodiment of the invention, the product carrier is rotated about a vertical axis. The part portions can hereby, for example, be arranged in ring shape, whereby a particularly appealing appearance results.

The product carrier can be removed from the conveying device before the movement and can be placed back on the conveying device after the movement. The removal, movement and placing down can take place, for example, by a handling apparatus, in particular by a transfer robot or by a pick-and-place robot. This is advantageous in that no complex and/or expensive adjustment mechanisms need to be provided at the conveying device.

In accordance with a further embodiment of the invention, more or fewer product slices are cut-off to form the first part potion than to form the second part portion. Irregular mixed portions can thereby also be prepared, whereby the flexibility of the plant is further increased.

At least two part portions, which are not formed directly following one another, can be formed on the product carrier from different tracks of a cutting apparatus which is configured for multitrack cutting. The efficiency and the flexibility of the plant can be further increased by the multitrack cutting. Products of different types can be supplied in the individual tracks of this cutting apparatus. Each track of a multitrack cutting apparatus can, like a single-track cutting apparatus, be considered as a “station” for preparing a part portion within the framework of the invention.

In accordance with an embodiment of the invention, the cutting apparatus are arranged spaced apart from one another along a conveyor track, for example a non-closed conveyor track, and the product carrier is moved along at least a part of the conveyor track in the forward direction and to and fro between at least two cutting apparatus in the backward direction. The conveyor track may extend substantially in a straight line. This allows the use of conveying devices of a particularly simple design. In this respect, at least one multitrack cutting apparatus can in particular be used which can be traveled to several times.

Furthermore, the cutting apparatus can be arranged spaced apart from one another in a closed loop, with the loop being run through more than once by the product carrier. This in particular has the advantage that the product carriers are available again immediately after the emptying and do not have to be moved back to the starting point by a diversion. In this respect, at least one multitrack cutting apparatus can in particular be used which can be traveled to several times.

The invention also relates to an apparatus for the automatic preparing of portions of a plurality of food products of different types by means of at least two cutting apparatus, for example high-performance slicers, comprising a conveying device which is configured to convey at least one product carrier from a product slice placement zone of a first cutting apparatus in which a part portion of at least one product slice of a first type is formed on the product carrier to a product slice placement zone of a second cutting apparatus in which a part portion of at least one product slice of a second type is formed on the product carrier which, together with the first portion, forms a desired total portion no longer to be complemented or a part portion still to be complemented by means of at least one further cutting apparatus. Such an apparatus allows in a simple manner an automatic preparation of portions of food products of different types, wherein the two cutting apparatus do not necessarily have to have a particularly high cutting performance.

At least one of the cutting apparatus can have a single-track product supply. At least one of the cutting apparatus can have a multitrack product supply. This cutting apparatus can be traveled to several times to prepare the total portion. This allows a particularly simple and inexpensive construction.

Furthermore, the conveying device can be configured for a conveying of the product carrier, in particular a linear conveying, along a straight and/or curved conveyor track, with the cutting apparatus being arranged spaced apart from one another along the conveyor track. In accordance with a preferred embodiment, the conveying device is a simple belt conveyor or an arrangement of belt conveyors arranged behind one another. However, multiband conveyors or roller conveyors can also be provided.

The conveying device can also be configured for conveying the product carrier along a loop closed per se, for example a circular loop, with the cutting apparatus being arranged spaced apart from one another along the loop. If the application requires, the conveying device can also include a combination of conveying sections closed per se and open.

The conveying device can furthermore be configured for a continuous conveying of a plurality of product carriers in a uniform product carrier distance, for example with the product carrier distance corresponding to the distance between the product slice placement zones of the cutting apparatus. Part portions can thus be cut simultaneously at a plurality of cutting apparatus, whereby the product performance of the plant is increased. A part portion can e.g. be produced at the second cutting apparatus, while a part portion for the next product carrier is already being produced at the preceding first cutting apparatus.

An actuator can furthermore be provided for displacing the product carrier relative to a support surface of the conveying device. The actuator can be integrated into the conveying device, for example in the form of a table movable within the support surface. Alternatively, the actuator can also be realized by a handling apparatus such as a transfer robot arranged outside the conveying device.

Alternatively or additionally, an actuator can be provided for rotating the product carrier about a vertical axis. This actuator can also be integrated in the conveying device, for example in the form of a rotary table, or can be realized by a handling apparatus located outside the conveying device.

In accordance with a further embodiment of the invention, an actuator is provided for a linear movement of the product carrier in and/or against the conveying direction or transversely to the conveying direction.

The product carrier can be fixedly coupled to the conveying device and can in particular be integrated in the conveying device. No apparatus is then required for providing empty product carriers or for moving back emptied product carriers. For example, product carriers can be mounted, for example movably, at regular intervals at the conveyor belt of a belt conveyor. Emptied product carriers are then automatically supplied to the output point at the lower run of the conveyor belt.

Alternatively, the product carrier can be removable from the conveying device and can for example only lie on a support surface of the conveying device. This in particular allows the use of standard product supports or trays as product carriers. If desired, different product carrier types can also be used on one conveying device.

The product carrier may be in form-fitted engagement with a conveyor belt of the conveying device configured as a belt conveyor. For example, a correct position of the product carrier within the belt surface is ensured by this form-fitted engagement.

The product carrier can be a package or a part of a package for the total portion, in particular a tray. The additional method step of the transfer of the total portion from the product carrier into the package can hereby be saved.

The invention furthermore relates to a production line for multitype packs which each contain a total portion of product slices of food products of a different type having an apparatus as described above and having a packaging machine.

Further developments of the invention are set forth in the dependent claims, in the description and in the enclosed drawings.

### BRIEF DESCRIPTION OF THE DRAWINGS

FIG. 1 is a simplified plan view of a production line for multipacks in accordance with a first embodiment of the invention;

FIG. 2 is an enlarged part representation of the production line in accordance with FIG. 1;

FIG. 3 shows a multitype pack which was prepared using a production line in accordance with the invention; and

FIG. 4 is a simplified plan view of a production line for multitype packs in accordance with a second embodiment of the invention.

### DETAILED DESCRIPTION

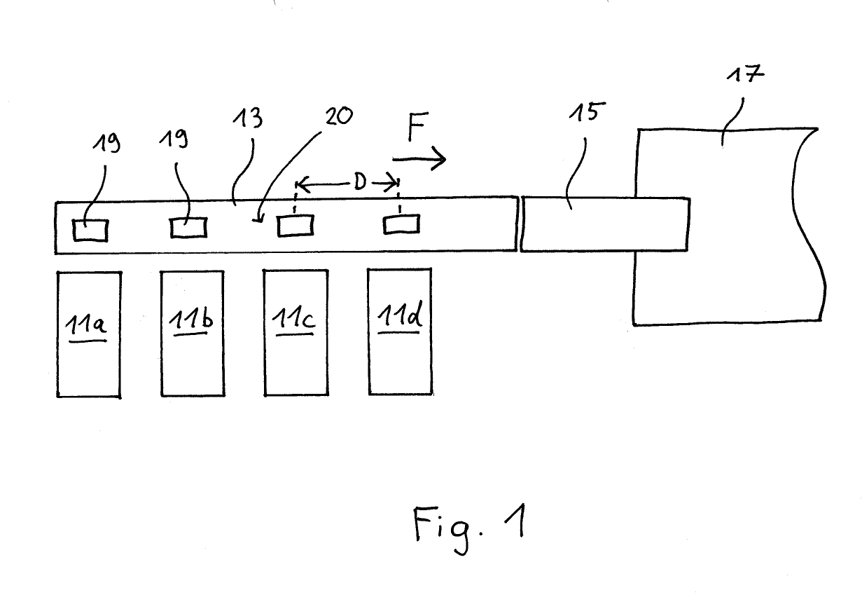

In accordance with FIG. 1, a production line for multitype packs includes four separate cutting apparatus 11a, 11b, 11c, 11d, a first conveying device 13, a second conveying device 15 and a packaging machine 17. The first conveying device 13 is a belt conveyor which is configured to convey product carriers 19 along a conveying direction F at a uniform distance D. The four cutting apparatus 11a-d are arranged next to the first conveying device 13 such that product slices cut off from them fall onto the conveyed product carrier 19. The cutting apparatus 11a-d are for example high-performance slicers of conventional design which include a single-track product supply and a cutting blade moving in a cutting plane. The cutting apparatus 11a-d are arranged such that the respective placement sites of the cut-off product slices are spaced from one another by the distance D.

Product portions prepared on the product carriers 19 move from the first conveying device 13 to the second conveying device 15 which is configured e.g. as a depositor and ensures that the product portions are handed over to the packaging machine 17 in a correct manner and are packaged there.

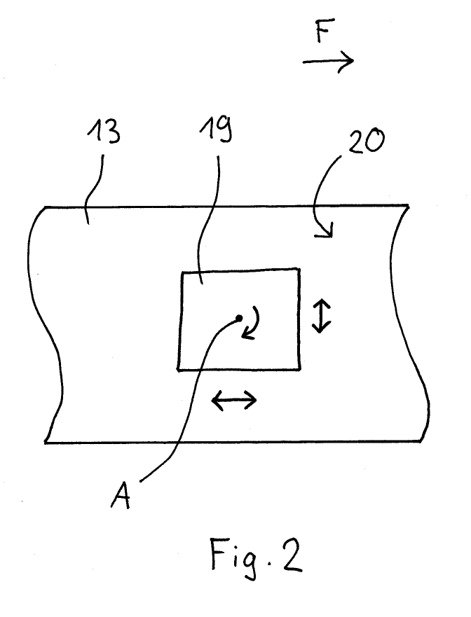

As can be seen from FIG. 2, the product carriers 19 are fixedly mounted at the first conveying device 13, but are movable with respect to a support surface 20 of the conveying device 13. For example, a plurality of actuators, not shown, ensure that the product carrier 19 can be displaced relative to the support surface 20, and indeed both in and against the conveying direction F and also transversely to the conveying direction F. A further actuator, likewise not shown, ensures that the product carriers 19 are additionally rotatable about a vertical axis A. After the handing over of a completed product portion to the second conveying device 15, the empty product carriers 19 at the lower run of the first conveyor device 13 are again returned to the starting point of the conveyor path.

In accordance with an alternative embodiment, the product carriers 19 are not attached to the conveying device 13, but rather only lie loosely on the support surface 20, with an external handling apparatus such as a transfer robot being provided for moving the product carriers 19.

The product feeds of the cutting apparatus 11a-d are each loaded in a generally known manner with product bars or product loaves, with the product bars or product loaves for the individual cutting apparatus 11a-d differing with respect to the product type.

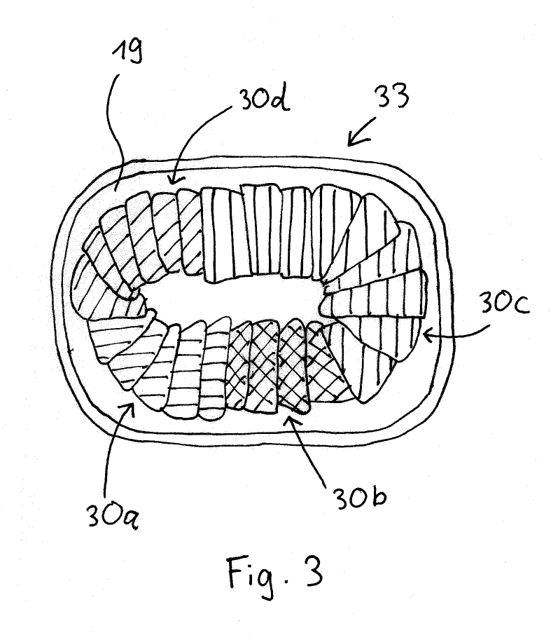

The preparing of portions by means of the production line in accordance with FIG. 1 will be described in the following, with reference additionally being made to FIG. 3 which shows an exemplary product carrier 19 with four part portions 30a, 30b, 30c, 30d of different types. The part portions 30a-d together form a mixed portion 33 in a round placement of food products of different types.

To prepare a total portion 33 of product slices of food products of different types, a plurality of product slices of a first type are first cut off by means of the first cutting apparatus 11a. These product slices fall onto the product carrier 19 and form a first part portion 30a, with the continuous movement of the product carrier 19 in the conveying direction F ensuring that the product slices of the first part portion 30a come to lie in an overlapping arrangement on the product carrier 19. The product carrier 19 is then conveyed further to the second cutting apparatus 11b which cuts off a plurality of product slices of a second product type. These product slices likewise fall onto the product carrier 19 and come to lie next to the product slices of the first type, preferably in direct overlapping sequence to them. A second part portion 30b is thus formed. The product carrier 19 is then conveyed in an analog manner to the third slicing apparatus 11c and to the fourth slicing apparatus 11d, with two further part portions 30c, 30d which are each formed by product slices of a further type being added to the part portions 30a, 30b already located on the product carrier 19. In this manner, a part portion 30a-d of an individual type is prepared at each of the cutting apparatus 11a-d, with the part portions 30a-d all being located on the product carrier 19 and thus forming the mixed total portion 33.

The product carrier 19 can also be conveyed to and fro between the cutting apparatus 11a-d in order thus to prepare a total portion 33 which is composed of more than four part portions 30a-d. That is, the number of part portions 30a-d can exceed the number of cutting apparatus 11a-d if desired.

The mixed total portion 33 is then handed over to the second conveying device 15 (FIG. 1) and is packaged in the packaging machine 17. A plurality of different placement patterns can be produced by moving the product carrier 19 between the preparation of the individual part portions 30a-d. An arrangement in a round placement is shown only by way of example in FIG. 3.

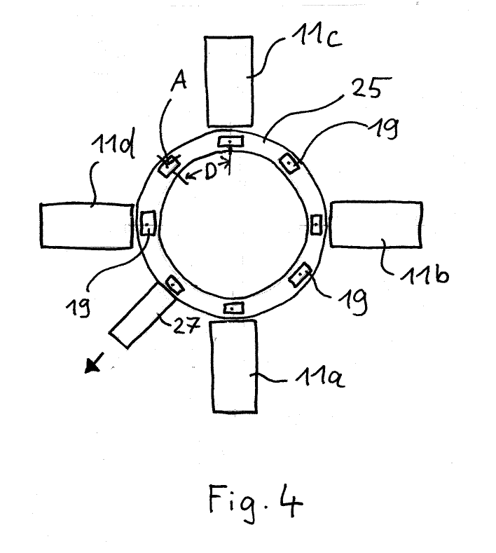

FIG. 4 shows a production line for multitype packages in accordance with an alternative embodiment of the invention, with four cutting apparatus 11a-d being arranged along a circular conveying device 25 which forms a loop closed per se. The loop is preferably run through a plurality of times by each product carrier 19. It is not necessary in this arrangement that emptied product carriers 19 are conveyed back by a diversion to the starting point of the conveying path 27 again. On a two-time running through of the loop, twice four, that is eight, part portions can e.g. be placed onto the product carrier 19. That means a total portion comprising eight types can be prepared.

The invention allows an efficient, fully automatic preparation of portions of a plurality of food products of different types, with the cutting apparatus 11a-d using being able to be relatively simple and each considered per se not having to have any particularly high cutting performance. Since all cutting apparatus 11a-d are always operated simultaneously, a high production performance is namely produced in the total sum. Provided no multitype packs are required, single-type packs can also be produced without problem with the same plant.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

1-15. (canceled)

16. A method for the automatic preparation of portions of a plurality of food products of different types with at least two cutting apparatus, the method comprising:
cutting off at least one product slice from a product of a first type with a first cutting apparatus, with the cut-off product slice of the first type falling onto a product carrier and forming a first part portion;
conveying the product carrier having the first part portion to a second cutting apparatus by a conveying device; and
cutting off at least one product slice of a second type with the second cutting apparatus, with the cut-off product slice of the second type falling onto the product carrier and forming a second part portion which complements the first part portion to form a desired total portion no longer to be complemented or to form a part portion still to be complemented using at least one further cutting apparatus.

17. A method in accordance with claim 16, wherein the cutting apparatus are high-performance slicers.

18. A method in accordance with claim 16, including moving the product carrier by an adjustment apparatus after the reception of the first part portion and before the reception of the second part portion such that the position of the second part portion on the product carrier relative to the position of the first part portion on the product carrier satisfies a predefined condition.

19. A method in accordance with claim 18, including displacing the product carrier relative to a support surface of the conveying device and/or rotating the product carrier about a vertical axis.

20. A method in accordance with claim 19, including displacing the product carrier relative to the support surface of the conveying device in or against a conveying direction or transversely to the conveying direction.

21. A method in accordance with claim 18, including removing the product carrier from the conveying device before the movement and placing the product carrier onto the conveying device again after the movement.

22. A method in accordance with claim 16, wherein more or fewer product slices are cut-off to form the first part portion than to form the second part portion.

23. A method in accordance with claim 16, wherein at least two part portions which are not formed directly subsequent to one another are formed on the product carrier from different tracks of a cutting apparatus which is configured for a multitrack cutting.

24. A method in accordance with claim 16, including arranging the cutting apparatus spaced apart from one another along a conveyor track, and moving the product carrier along at least a part of the conveyor track in a forward direction and to and fro between at least two cutting apparatus; and/or arranging the cutting apparatus spaced apart from one another along a loop and the loop is run through more than once by the product carrier.

25. A method in accordance with claim 24, wherein the conveyor track is a non-closed conveyor track.

26. An apparatus for the automatic preparation of portions from a plurality of food products of different types with at least two cutting apparatus, the apparatus comprising:
a conveying device configured to convey at least one product carrier from a product slice placement zone of a first cutting apparatus to a product slice placement zone of a second cutting apparatus, wherein a first part portion is formed from at least one product slice of a first type on the product carrier in the placement zone of the first cutting apparatus, and a second part portion of at least one product slice of a second type is formed on the product carrier in the placement zone of the second cutting apparatus, and wherein the second part portion and the first part portion form a desired total portion no longer to be complemented or a part portion still to be complemented by at least one further cutting apparatus.

27. An apparatus in accordance with claim 26, wherein the cutting apparatus are high-performance slicers.

28. An apparatus in accordance with claim 26, wherein at least one of the cutting apparatus has a single-track product feed and/or at least one of the cutting apparatus has a multitrack product feed.

29. An apparatus in accordance with claim 26, wherein the conveying device is configured for conveying the product carrier along a straight and/or curved conveyor track, the cutting apparatus being arranged spaced apart from one another along the conveyor track.

30. An apparatus in accordance with claim 29, wherein the conveying device is configured for conveying the product carrier linearly along the conveyor track.

31. An apparatus in accordance with claim 26, wherein the conveying device is configured for conveying the product carrier along a loop, with the cutting apparatus being arranged spaced apart from one another along the loop.

32. An apparatus in accordance with claim 31, wherein the loop is a circular loop.

33. An apparatus in accordance with claim 26, wherein the conveying device is configured for a continuous conveying of a plurality of product carriers at a uniform distance.

34. An apparatus in accordance with claim 33, wherein the product carrier distance corresponds to the distance between the product slice placement zones of the cutting apparatus.

35. An apparatus in accordance with claim 26, further comprising a first actuator for displacing the product carrier relative to a support surface of the conveying device, and/or further comprising a second actuator for rotating the product carrier about a vertical axis.

36. An apparatus in accordance with claim 26, further comprising an actuator for the linear movement of the product carrier in and/or against a conveying direction or transversely to the conveying direction; and/or wherein the product carrier is fixedly coupled to the conveying device, and/or wherein the product carrier is integrated into the conveying device.

37. An apparatus in accordance with claim 26, wherein the product carrier is removable from the conveying device, and/or wherein the product carrier is in form-fitted engagement with a conveyor belt of the conveying device formed as a belt conveyor.

38. An apparatus in accordance with claim 37, wherein the product carrier only lies on a support surface of the conveying device.

39. An apparatus in accordance with claim 26, wherein the product carrier is a package or a part of a package for the total portion.

40. A production line for multitype packs each containing a total portion of product slices of food products of different types, the production line comprising:
an apparatus configured for automatic preparation of portions from a plurality of food products of different types, the apparatus comprising:
a first cutting apparatus;
a second cutting apparatus; and
a conveying device configured to convey at least one product carrier from a product slice placement zone of the first cutting apparatus to a product slice placement zone of the second cutting apparatus, the apparatus configured such that a first part portion is formable from at least one product slice of a first type on the product carrier in the placement zone of the first cutting apparatus, a second part portion of at least one product slice of a second type is formable on the product carrier in the placement zone of the second cutting apparatus, and the second part portion and the first part portion form the total portion no longer to be complemented or a part portion still to be complemented by at least one further cutting apparatus; and
a packaging machine.
